(19) United States
(12) Patent Application Publication
(10) Pub. No.: US 2020/0372780 A1
(43) Pub. Date: Nov. 26, 2020

(54) Heatstroke Alert Assembly

(71) Applicant: Cyril Griffin, Sparta, TN (US)

(72) Inventor: Cyril Griffin, Sparta, TN (US)

(21) Appl. No.: 16/419,107

(22) Filed: May 22, 2019

(51) Int. Cl. G08B 21/04

(52) U.S. Cl. CPC G08B 21/0453

(57) ABSTRACT

A heatstroke alert assembly includes a housing that is attachable to an inner surface of an article of headwear. A temperature sensor is coupled to the housing to sense the temperature beneath the headwear when the headwear is being worn. A speaker is coupled to the housing to emit an audible alert outwardly therefrom when the temperature sensor senses a temperature that exceeds the predetermined trigger temperature. Thus, the speaker alerts a user that the user is in danger of developing heat stroke. A transceiver is coupled to the housing and the transceiver communicates an alert signal to a remote electronic device when the temperature sensor senses a temperature that exceeds the pre-determined trigger temperature. In this way the transceiver alerts a supervisor that the user is at risk of developing heat stroke.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to alert devices and more particularly pertains to a new alert device for alerting a person to the risk of developing heatstroke.

### BRIEF SUMMARY OF THE INVENTION

An embodiment of the disclosure meets the needs presented above by generally comprising a housing that is attachable to an inner surface of an article of headwear. A temperature sensor is coupled to the housing to sense the temperature beneath the headwear when the headwear is being worn. A speaker is coupled to the housing to emit an audible alert outwardly therefrom when the temperature sensor senses a temperature that exceeds the predetermined trigger temperature. Thus, the speaker alerts a user that the user is in danger of developing heat stroke. A transceiver is coupled to the housing and the transceiver communicates an alert signal to a remote electronic device when the temperature sensor senses a temperature that exceeds the pre-determined trigger temperature. In this way the transceiver alerts a supervisor that the user is at risk of developing heat stroke.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a heatstroke alert assembly according to an embodiment of the disclosure.

FIG. 2 is a bottom phantom view of an embodiment of the disclosure.

FIG. 3 is an exploded perspective view of an embodiment of the disclosure.

FIG. 4 is a cut-away in-use view of an embodiment of the disclosure.

FIG. 5 is a phantom in-use view of an embodiment of the disclosure.

### DETAILED DESCRIPTION OF THE INVENTION

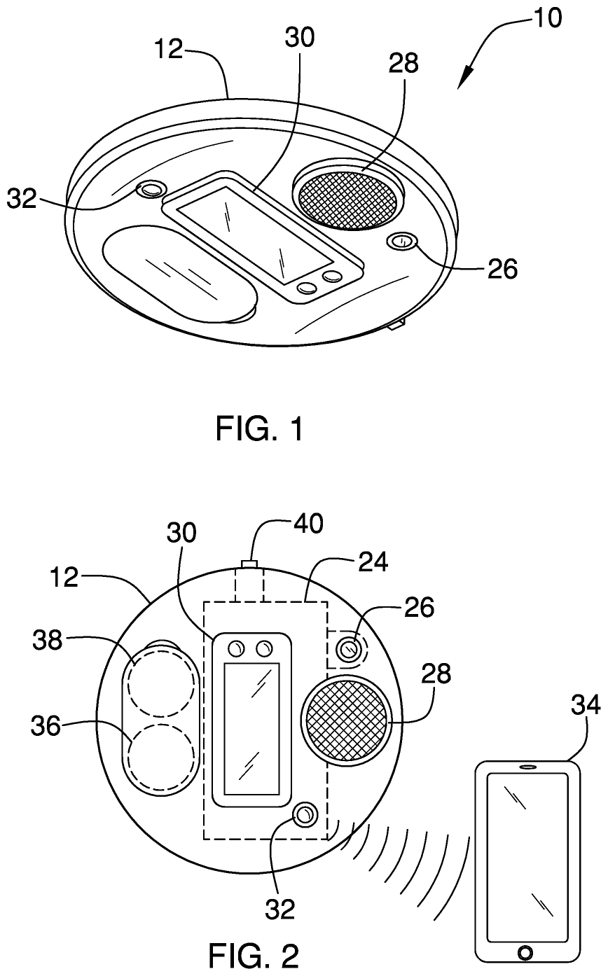

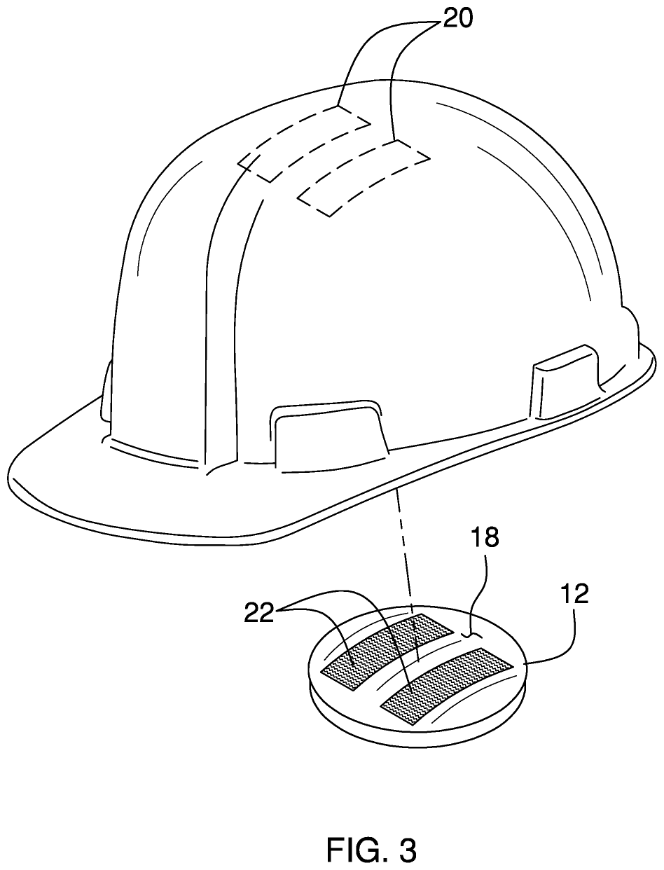

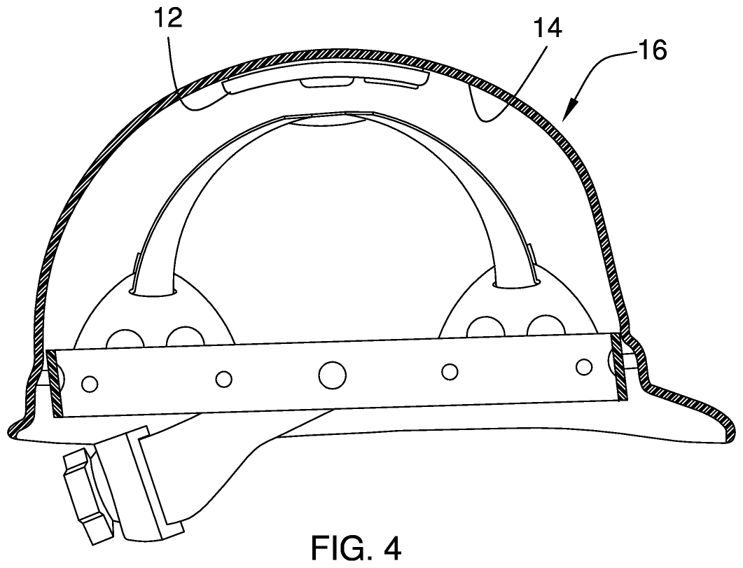

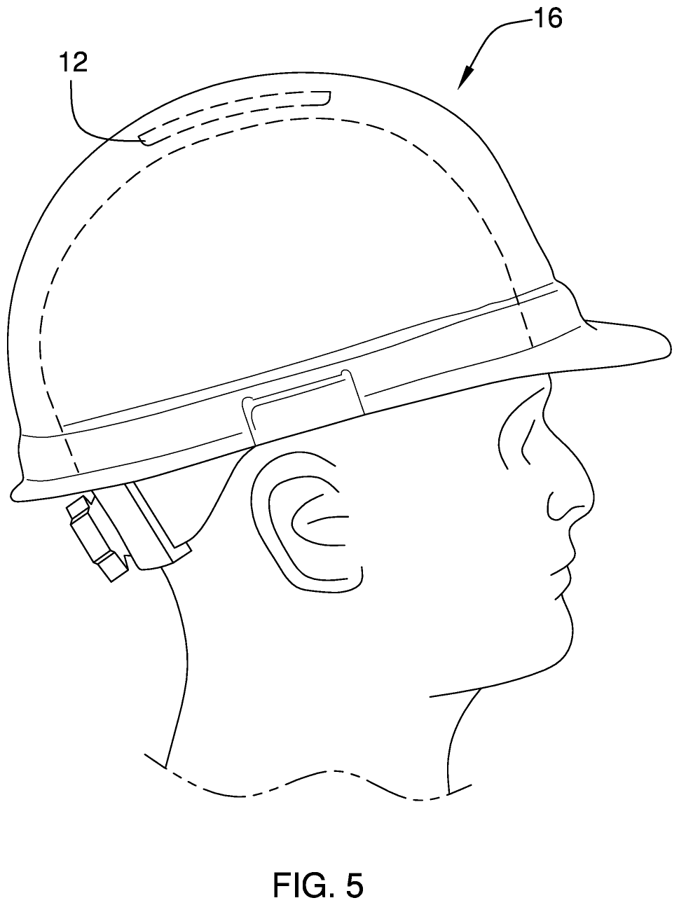

With reference now to the drawings, and in particular to FIGS. 1 through 5 thereof, a new alert device embodying the principles and concepts of an embodiment of the disclosure and generally designated by the reference numeral 10 will be described.

As best illustrated in FIGS. 1 through 5, the heatstroke alert assembly 10 generally comprises a housing 12 is attachable to an inner surface 14 of an article of headwear 16. The housing 12 has a first surface 18 and the housing 12 may have the shape of a flattened disk or other low profile shape. In this way the housing 12 does not contact a user's head when the article of headwear 16 is being worn. The article of headwear 16 may be a safety helmet or any other article of headwear commonly worn outdoors.

A first mating member 20 is coupled to the inner surface 14 of the article of headwear 16 and a second mating member 22 is coupled to the first surface 18 of the housing 12. The second mating member 22 releasably engages the first mating member 20 to retain the housing 12 on the inner surface 14 of the article of headwear 16. Each of the first 20 and second 22 mating members may be hook and loop fasteners or other type of releasable fastener.

A control circuit 24 is coupled to the housing 12 and the control circuit 24 receives an alert input. A temperature sensor 26 is coupled to the housing 12 to sense the temperature beneath the headwear 16 when the headwear 16 is being worn. The temperature sensor 26 is electrically coupled to the control circuit 24 and the control circuit 24 receives the alert input when the temperature sensor 26 senses a temperature that exceeds a pre-determined trigger temperature. The temperature sensor 26 may be an electronic temperature sensor or the like. The pre-determined trigger temperature may be a heat index temperature of 90.0 degrees Fahrenheit.

A speaker 28 is coupled to the housing 12 to emit an audible alert outwardly therefrom. The speaker 28 is in communication with the temperature sensor 26. The speaker 28 emits the audible alert when the temperature sensor 26 senses a temperature that exceeds the predetermined trigger temperature. The speaker 28 is electrically coupled to the control circuit 24. The speaker 28 is turned on when the control circuit 24 receives the alert input to alert a user that the user is in danger of developing heat stroke.

A display 30 is coupled to the housing 12 and the display 30 is electrically coupled to the control circuit 24. The display 30 displays indicia comprising a temperature readout corresponding to the temperature sensed by the temperature sensor 26. In this way the display 30 can communicate the temperature beneath the headwear 16 to the user. The display 30 may be an LED or other type of electronic display.

A transceiver 32 is coupled to the housing 12 and the transceiver 32 is in communication with the temperature sensor 26. The transceiver 32 is in electrical communication with a remote electronic device 34, which may be a smart phone or the like. The transceiver 32 may be a radio frequency transceiver 32 or the like and the transceiver 32 may employ Bluetooth communication protocols. The transceiver 32 communicates an alert signal to the remote electronic device 34 when the temperature sensor 26 senses a temperature that exceeds the pre-determined trigger temperature. In this way the transceiver 32 can alert a supervisor that the user is at risk of developing heat stroke. The transceiver 32 is electrically coupled to the control circuit 24 and the transceiver 32 transmits the alert signal when the control circuit 24 receives the alert input.

A power supply 36 is coupled to the housing 12 and the power supply 36 is electrically coupled to the control circuit 24. The power supply 36 comprises at least one rechargeable battery 38 is positioned in the housing 12. The at least one rechargeable battery 38 is electrically coupled to the control circuit 24. The power supply 36 includes a charge port 40 coupled to the housing 12 and the charge port 40 is electrically coupled to the at least one rechargeable battery 38. The charge port 40 can be electrically coupled to a charger for charging the at least one rechargeable battery 38.

In use, the housing 12 is positioned in the article of headwear 16 prior to wearing the article of headwear 16 being worn. In this way the temperature sensor 26 can sense the temperature between the article of headwear 16 and the user's head. The speaker 28 emits the audible alarm and the transceiver 32 transmits the alert signal when the temperature sensor 26 senses the temperature above the pre-determined trigger temperature. In this way both the user and a supervisor are alerted that the user is in danger of developing heat stroke. Thus, the user can take the necessary steps to protect themselves from developing heat stroke.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A heatstroke alert assembly comprising:
an article of headwear configured for being worn on a head;
a housing being attachable to an inner surface of the article of headwear such that the housing is configured for being positioned spaced above the head;
a temperature sensor being coupled to said housing wherein said temperature sensor is configured to sense the temperature beneath the headwear when the headwear is being worn;
a speaker being coupled to said housing wherein said speaker is configured to emit an audible alert outwardly therefrom, said speaker being in communication with said temperature sensor, said speaker emitting the audible alert when said temperature sensor senses a temperature that exceeds the predetermined trigger temperature wherein said speaker is configured to alert a user that the user is in danger of developing heat stroke;
a transceiver being coupled to said housing, said transceiver being in electrical communication with a remote electronic device, said transceiver being in communication with said temperature sensor, said transceiver communicating an alert signal to the remote electronic device when said temperature sensor senses a temperature that exceeds the pre-determined trigger temperature wherein said transceiver is configured to alert a supervisor that the user is at risk of developing heat stroke.

2. The assembly according to claim 1, wherein:
said housing has a first surface;
said assembly includes a first mating member being coupled to the inner surface of the article of headwear; and
said assembly includes a second mating member being coupled to said first surface of said housing, said second mating member releasably engaging said first mating member to retain said housing on the inner surface of the article of headwear.

3. The assembly according to claim 1, wherein:
said assembly includes a control circuit being coupled to said housing, said control circuit receiving an alert input; and
said temperature sensor is electrically coupled to said control circuit, said control circuit receiving said alert input when said temperature sensor senses a temperature that exceeds a pre-determined trigger temperature.

4. The assembly according to claim 3, wherein said speaker is electrically coupled to said control circuit, said speaker being turned on when said control circuit receives said alert input.

5. The assembly according to claim 4, further comprising a display being coupled to said housing, said display being electrically coupled to said control circuit, said display displaying indicia comprising a temperature readout corresponding to the temperature sensed by said temperature sensor wherein said display is configured to communicate the temperature beneath the headwear to the user.

6. The assembly according to claim 5, wherein said transceiver is electrically coupled to said control circuit, said transceiver transmitting said alert signal when said control circuit receives said alert input.

7. The assembly according to claim 2, further comprising a power supply being coupled to said housing, said power supply being electrically coupled to said control circuit, said power supply comprising:
at least one rechargeable battery being positioned in said housing, said at least on rechargeable battery being electrically coupled to said control circuit; and
a charge port being coupled to said housing, said charge port being electrically coupled to said at least one rechargeable battery, said charge port being configured to be electrically coupled to a charger for charging said at least one rechargeable battery.

8. A heatstroke alert assembly comprising:
an article of headwear configured for being worn on a head;
a housing being attachable to an inner surface of the article of headwear such that the housing is configured for being positioned spaced above the head, said housing having a first surface;
a first mating member being coupled to the inner surface of the article of headwear;
a second mating member being coupled to said first surface of said housing, said second mating member releasably engaging said first mating member to retain said housing on the inner surface of the article of headwear;
a control circuit being coupled to said housing, said control circuit receiving an alert input;
a temperature sensor being coupled to said housing wherein said temperature sensor is configured to sense the temperature beneath the headwear when the headwear is being worn, said temperature sensor being electrically coupled to said control circuit, said control circuit receiving said alert input when said temperature sensor senses a temperature that exceeds a pre-determined trigger temperature;
a speaker being coupled to said housing wherein said speaker is configured to emit an audible alert outwardly therefrom, said speaker being in communication with said temperature sensor, said speaker emitting the audible alert when said temperature sensor senses a temperature that exceeds the predetermined trigger temperature, said speaker being electrically coupled to said control circuit, said speaker being turned on when said control circuit receives said alert input wherein said speaker is configured to alert a user that the user is in danger of developing heat stroke;
a display being coupled to said housing, said display being electrically coupled to said control circuit, said display displaying indicia comprising a temperature readout corresponding to the temperature sensed by said temperature sensor wherein said display is configured to communicate the temperature beneath the headwear to the user;
a transceiver being coupled to said housing, said transceiver being in electrical communication with a remote electronic device, said transceiver being in communication with said temperature sensor, said transceiver communicating an alert signal to the remote electronic device when said temperature sensor senses a temperature that exceeds the pre-determined trigger temperature wherein said transceiver is configured to alert a supervisor that the user is at risk of developing heat stroke, said transceiver being electrically coupled to said control circuit, said transceiver transmitting said alert signal when said control circuit receives said alert input; and
a power supply being coupled to said housing, said power supply being electrically coupled to said control circuit, said power supply comprising:
at least one rechargeable battery being positioned in said housing, said at least on rechargeable battery being electrically coupled to said control circuit; and
a charge port being coupled to said housing, said charge port being electrically coupled to said at least one rechargeable battery, said charge port being configured to be electrically coupled to a charger for charging said at least one rechargeable battery.
